(19) United States
(12) Patent Application Publication
(10) Pub. No.: US 2025/0363448 A1
(43) Pub. Date: Nov. 27, 2025

(54) INTEGRATED PERISHABLE SHRINK MANAGEMENT SYSTEM

(71) Applicant: TOSHIBA GLOBAL COMMERCE SOLUTIONS, INC., Durham, NC (US)

(72) Inventors: Yevgeni TSIRULNIK, Frisco, TX (US); Susan W. BROSNAN, Raleigh, NC (US); Brian D. TAYLOR, Durham, NC (US); Kirk GOLDMAN, Cary, NC (US); Manda MILLER, Raleigh, NC (US); Theodore R. CLARK, Allendale, NJ (US); James L. FRANK, Montreal (CA); Kristen M. CHUNG, Cornelius, NC (US); Pawita SUNTHORNPONG, Chapel Hill, NC (US); Samuel C. CHAMPAGNE, Raleigh, NC (US)

(21) Appl. No.: 18/670,665

(22) Filed: May 21, 2024

(51) Int. Cl. G06Q 10/087; G06Q 30/0283; G06V 20/60

(52) U.S. Cl. CPC G06Q 10/087; G06Q 30/0283; G06V 20/60

(57) ABSTRACT

Methods and apparatus for dynamic pricing adjustment and inventory optimization are provided. Stock level data is received via a camera, where the stock level data comprises an estimated stock level of a product batch within a physical site. Product information for the product batch is retrieved from a database, where the product information comprises an expiration date and a first price for the product price. A second price for the product batch is calculated using a machine learning (ML) model based on the expiration date and the estimated stock level. The database is updated with the second price for the product batch.

### BACKGROUND

Products, such as dairy products, fruits, vegetables, and baked goods, are highly susceptible to perishable shrink in retail environments, primarily because of their rapid deterioration rates and short shelf lives. The increase in perishable shrink for these products is typically caused by an imbalance between supply and demand. For example, there may be excess inventory that cannot be consumed in time if stock levels are higher than customer demand. Additionally, perishable shrink can be worsened by unpredictable fluctuations in consumer purchasing behavior, which are influenced by a variety of factors such as seasonal trends, weather conditions, and economic changes. Such perishable shrink not only causes financial losses for stores, but also has a detrimental impact on the environment.

### BRIEF DESCRIPTION OF THE DRAWINGS

FIG. 1 depicts an example environment for perishable shrink control and management, according to some embodiments of the present disclosure.

FIG. 2 depicts an example perishable shrink control system, according to some embodiments of the present disclosure.

FIG. 3 depicts an example electronic shelf label (ESL), according to some embodiments of the present disclosure.

FIG. 4 depicts an example method for controlling perishable shrink through dynamic pricing and inventory management, according to some embodiments of the present disclosure.

FIG. 5 depicts an example method for ESL devices updating and displaying prices, according to some embodiments of the present disclosure.

FIG. 6 depicts an example method for Point of Sale (POS) devices retrieving updated prices upon product scanning, according to some embodiments of the present disclosure.

FIG. 7 is a flow diagram depicting an example method for dynamic pricing and inventory monitoring, according to some embodiments of the present disclosure.

FIG. 8 depicts an example computing device configured to perform various aspects of the present disclosure, according to some embodiments of the present disclosure.

### DETAILED DESCRIPTION

Embodiments herein describe a system for waste management and control based on dynamic pricing adjustments and real-time inventory monitoring.

Products, such as dairy products, fruits, vegetables, and baked goods, usually have a relatively short shelf life, making them highly susceptible to perishable shrink in retail environments. To reduce perishable shrink, a common strategy involves reducing prices to incentivize customers to purchase more. However, conventionally, retailers may apply price reductions arbitrarily without a data-driven understanding of how much the price should be reduced or what discount should be applied to effectively minimize perishable shrink and optimize inventory levels. Optimizing inventory levels through strategic price reduction can significantly increase revenue and improve profit margin. However, the lack of a data-driven approach for price adjustment may undermine these potential benefits, leading to inadequate pricing strategies that neither significantly reduce water nor enhance profitability.

The present disclosure addresses these challenges by introducing a perishable shrink management and control system that uses machine learning (ML) models and real-time data from edge cameras to dynamically adjust prices. As used herein, perishable shrink (also referred to in some embodiments as retail shrink) refers to the loss of inventory for perishable products (e.g., milk, baked products, vegetables) in retail stores due to damage or expiration. In some embodiments, perishable shrink (or retail shrink) may be determined by calculating the difference between the amount of inventory purchased and the amount of inventory actually sold. In some embodiments, the prices for perishable products may be adjusted based on estimated stock levels of product batches, expiration dates, calculated product margin, and anticipated near-future deliveries (or stock levels) arriving at the store. The system allows for a data-driven decision-making process regarding price adjustments, which not only minimizes (or at least reduces) perishable shrink by encouraging the timely purchase of perishable items, but also maintains improved inventory levels. Through the dynamic price adjustments, the system may improve overall retail efficiency and sustainability.

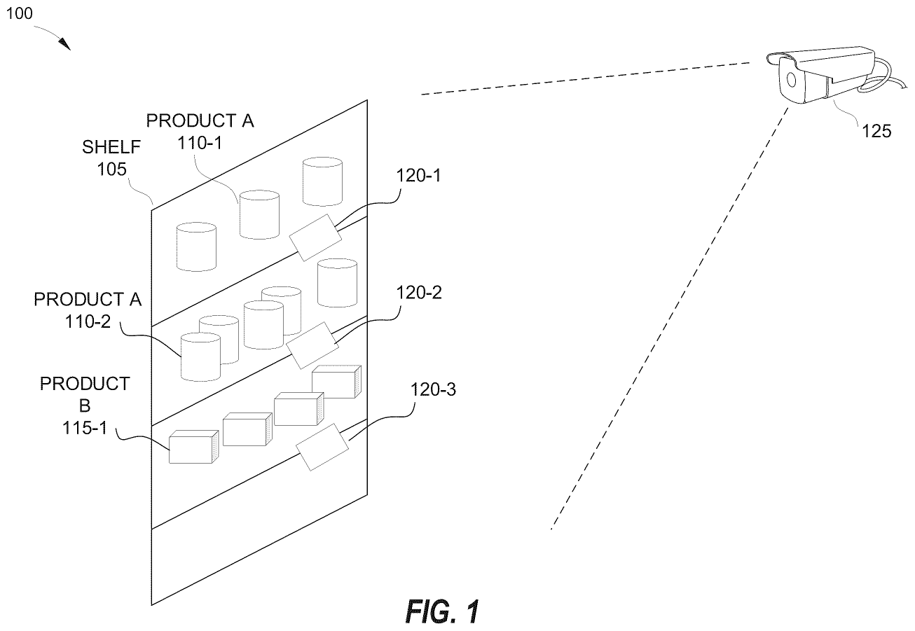

FIG. 1 depicts an example environment 100 for perishable shrink control and management, according to some embodiments of the present disclosure.

The environment 100 may correspond to an enterprise site, such as a retail establishment (e.g., supermarkets, grocery stores, bakery stores). The illustrated environment 100 includes a shelf 105 with three levels. Different shelf levels are used to display either distinct products or the identical products but from different batches. For example, as illustrated, the top shelf level displays items belonging to Product A (e.g., milk), Batch 110-1. The middle shelf level displays items belonging to Product A, Batch 110-2. The bottom shelf level displays items belonging to Product B (e.g., sandwich), Batch 115-1. As used herein, items within the same batch may share the same characteristics, such as weight, production date, or expiration date, indicating that the items are from the same production cycle. For example, the items within Product A (e.g., milk), Batch 110-1 may share an expiration date or have expiration dates that fall within a defined range (e.g., plus or minus 3 days). Items within Product A, Batch 110-2 are different from items within Product A, Batch 110-1 in one or more of these characteristics, such as having a later expiration date that exceed the defined range, which indicates items within Batch 110-2 are from a different production cycle.

As illustrated, shelf input/output (IO) devices 120 are used to indicate the difference in product types and batches. For example, shelf IO device 120-1 is attached on the top level of the shelf 105, showing information related to Product A, Batch 110-1. Shelf IO device 120-2 is attached on the middle level of the shelf 105, displaying information related to Product A, Batch 110-2. Shelf IO device 120-3 is attached on the bottom level of the shelf 105, showing information related to Product B, Batch 115-1.

In some embodiments, the Shelf IO devices 120 may provide a variety of information related to each product batch, including the product name, description, pricing details (such as unit price or total price), product ID (e.g., a Stock Keeping Unit (SKU)), discount information, current stock count (including shelf and backroom), and environmental certification (e.g., Organic, Fair Trade). Additionally, various types of barcodes, such as the GS1 Logistic Label barcode (1D barcode) or GS1 Digital Link barcode (QR code), may be displayed within the Shelf IO devices 120 to facilitate easy product identification.

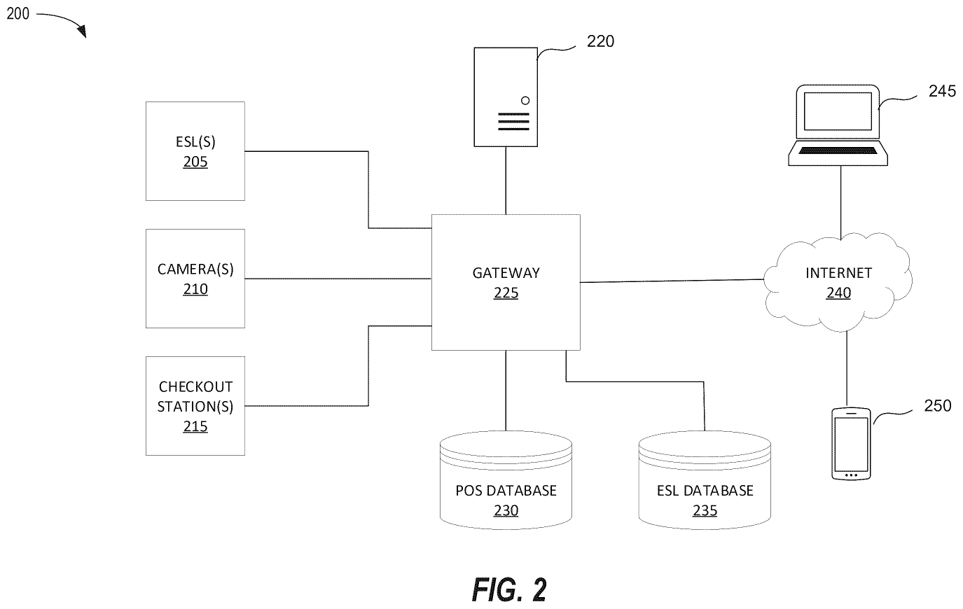

In the illustrated environment 100, a camera 125 is installed close to the shelf 105. The camera 125 may be either wall-mounted or ceiling-mounted, and pointed directly towards the shelf 105 to ensure it has a clear view of the shelf 105 and its contents. In some embodiments, the camera 125 may be configured to capture images of the shelf 105 at regular intervals or in real time. The captured images may then be transmitted as raw image data to a server for further processing and analysis. The transmission may occur over a wired or wireless network, as discussed in more detail with reference to FIG. 2. Upon receiving the raw image data, the server may use image processing and recognition algorithms to analyze the contents of each image. These algorithms may be configured to identify the product types (e.g., Product A) and batches (e.g., Batch 110-1) of the items on the shelf 105 by recognizing unique features such as packaging design, labels, or barcodes (printed on their packaging or displayed on the shelf IO devices 120). Based on the identified product types and batches, the server may then assess stock levels by either counting the visible items or estimating the quantity of items present, considering the items' arrangement and the space they occupy on the shelf. For example, through analyzing images of the shelf 105, the server may identify items on the top shelf belonging to Product A (e.g., milk), Batch 110-1, and determine that there are three items present in this category, indicating that the current stock level for Product A, Batch 110-1, is three. Similarly, the server may identify items on the middle level as to Product A, Batch 110-2, and indicate that the current stock level for this category is 5. Additionally, the server may identify items on the bottom shelf level as to Product B, Batch 115-1, and indicate the current stock level for this category is 4.

In some embodiments, following the recognition of product categories (including product types and batches), the server may proceed to search a database to access more detailed product information (extending beyond what has been directly identified within the image), such as the expiration date, manufacturer information, ingredient list, and historical sales data, among others. Utilizing the product information, along with the estimated stock levels and/or estimated future stock levels from supply chain ordering systems, the server may determine price adjustments for different products (e.g., Product A, Product B) or different batches of the same product (e.g., Batch 110-1, Batch 110-2). In some embodiments, price adjustments may be determined by running a trained ML model. The training process may begin with the collection of a dataset that includes historical patterns of sales, price changes, customer responses, one or more products' expiration dates and their corresponding stock levels, and other relevant variables. The historical data may be gathered from the store's transaction records or inventory management systems. The historical data, once collected, may be cleaned and preprocessed to resolve inconsistencies and fill in missing values, making it more suitable for training. From the preprocessed data, input features and target outputs may be identified and extracted. As used herein, input features may refer to variables that potentially impact sales and inventory turnover, such as time-to-expiration, and historical demand trends for similar products at similar times. Target outputs may refer to the price adjustment that incurs minimal (or at least reduced) perishable shrink (regression), or a decision whether to reduce price (binary classification).

Once the data is prepared, in some embodiments, the model may be trained using the historical data to learn the correlations between the input features and the target outputs. Various algorithms may be used, depending on the complexity of the data and/or the specific requirements of the application. These algorithms may include, but are not limited to, regression trees, support vector machines (SVM), random forests, or neural networks. In some embodiments, the model's performance may be measured through validation techniques such as k-fold cross-validation. In some embodiments, the model may be iteratively refined to update with new data that captures the latest market conditions and consumer behavior. Through the training, the model is adapted to predict price adjustments that allow for minimal (or at least reduced) perishable shrink based on newly received data. The data-driven price adjustment process enables effective management of inventory, such as reducing prices to accelerate sales, which in turn minimizes (or at least reduces) predictable perishable shrink. Additionally, the dynamic nature of the data-driven price adjustment process allows for real-time responses to changes in market conditions, inventory status, and expiration dates of products. As new data on sales, customer demand variations, inventory levels, and nearing expiration dates are incorporated, the model may adjust its predictions to provide the most effective pricing strategy at any given time.

In some embodiments, the camera 125 may have built-in processing capabilities (also referred to in some embodiments as an edge camera), which allows more efficient data handling and analysis. Instead of transmitting raw image data to the server, the camera 125 may analyze the images directly to identify products and determine relevant stock levels. After processing the images, the camera 125 may then transmit compiled information, such as product identifiers, batch details, and estimated stock levels, to the server. The usage of edge cameras in the retail environment 100 may reduce the bandwidth needed for data transfer and/or lower the computational load on the central server. Such integration may facilitate a faster response to stock level changes, as the server receives processed data ready for immediate use in inventory management and dynamic pricing adjustments.

FIG. 2 depicts an example perishable shrink control system 200, according to some embodiments of the present disclosure. The figure illustrates the network architecture of the example system 200 within an enterprise site (e.g., a retail store). As illustrated, the perishable shrink control system 200 includes a gateway 225 that acts as the central hub for data transmission. The gateway 225 connects various components within the perishable shrink control system 200 for dynamic pricing and inventory management. These components include electronic shelf labels (ESLs) 205, cameras 210, checkout stations 215, a central server 220, the Point of Sale (POS) database 230, and the ESL database 235, all of which communicate with each other via the gateway 225.

In some embodiments, the ESLs 205 may correspond to the shelf IO devices 120 as depicted in FIG. 1. The ESLs 205 may be attached to shelves and utilized to dynamically display the current pricing information for products. In some embodiments, The ESLs 205 may receive (or actively retrieve) pricing updates from the ESL database 235, to ensure that the displayed prices are up-to-date.

In some embodiments, the camera(s) 210 may correspond to the camera 125 as depicted in FIG. 1. In some embodiments, the cameras 210 may be standard surveillance cameras, which capture images of store shelves (e.g., 105 of FIG. 1) and transmit them to the central server 220 for analysis. In some embodiments, the cameras 210 may be edge cameras, configured with built-in processing capabilities. The edge cameras may process the images locally, to identify the products and their respective stock levels. The edge cameras may then send the processed data to the server for dynamic price adjustments.

In some embodiments, the checkout stations 215 in retail environments may be configured to calculate accurate billing, and/or help customers to complete their purchases. For accurate billing, the checkout station 215 may scan labels or barcodes (either GS1 logical labels or GS1 Digital Link barcodes) printed on products within a shopping cart. Upon scanning, the checkout station 215 may send a request through the gateway 225 to the POS database 230 to retrieve the most current product information. In some embodiments, the information retrieval may include the product name, description, and the current price, which may have been dynamically adjusted based on stock levels or other factors. The checkout station 215 may then calculate the total price based on the updated price and the quantity of items, to ensure customers are charged accurately according to the up-to-date pricing information.

In some embodiments, the server 220 may process images from the camera 210 (installed throughout the site) to identify products on the shelves, and/or evaluate their respective stock levels. Following the product identification, the server 220 may also retrieve additional product information from the ESL database 235, such as expiration dates for perishable items. Utilizing the received data, including but not limited to the expiration date and the evaluated stock levels, the server 220 may then determine the dynamic pricing adjustments for each product type and respective batches. In some embodiments, a ML model may be used to refine and enhance the decision-making process. The ML model may analyze historical sales data following price changes, customer behavior patterns, and other relevant factors to predict price adjustments that maximize (or at least improve) sales and profitability while ensuring inventory is managed effectively. Upon determining the price adjustments, the server may communicate with both the PoS database 230 and ESL database 235, providing them with the updated pricing information. The communication ensures consistency across retail operations, as the ESLs 205 display the updated price directly on the store shelves, and the checkout stations 215 apply the latest prices during the billing process. By updating these databases 230 and 235, the server 220 ensures that the retail devices are synchronized and offer customers accurate, transparent, and up-to-date pricing information.

In some embodiments, the gateway 225 may possess both router and modem capabilities, and serve as the central hub for both internal and external data transmission. As illustrated, the gateway 225 provides connectivity to the Internet 240, which enables store managers, staff, and even customers to engage with the system from any location. For example, through the Internet 240, store managers and staff may monitor and manage pricing and inventory levels from any location using their computers 245, smart phones 250, or other computing devices. In embodiments where errors arise during the pricing adjustment process, such as ESLs failing to update their displays or the databases not responding or returning incomplete information, the server 220 may send notifications automatically through the Internet 240 to the staff's devices, such as their smart phones 250 or computers 245. The notifications ensure that the staff are immediately aware of any operational issues, and/or take relevant actions to minimize disruption to the pricing system. In embodiments where the server determines, in addition to or instead of price adjustment, that the supply of certain products (e.g., sandwiches) should be reduced (based on analysis of historical sales data, market trends, and/or future inventory supply deliveries), the server 220 may send notifications through the Internet 240 to the devices of those at the supply chain management end (e.g., the kitchen). The notifications allow the staff involved in supply chain management to adjust their production or distribution plans accordingly.

In some embodiments, the remote access capability provided by the gateway 225, through its connection to the Internet 240, may extend to customers. For example, customers may use their personal devices, such as smart phones 250, to scan the barcodes displayed on the ESLs 205. Upon scanning, customers may access the ESL database 235 through the Internet 240 to view updated prices and other product information.

In some embodiments, the connections between the various components (e.g., the ESLs 205, the cameras 210, the checkout stations 215, the server 220, the PoS database 230, and the ESL database 235) within the perishable shrink control system 200 and the gateway 225 may be either wired or wireless, depending on the requirements, constraints, and capabilities of the network infrastructure.

Although the PoS database 230 and the ESL database 235 are depicted as two separate components within the perishable shrink control system 200, in some embodiments, a single and centralized database may be used. In this configuration, both PoS devices (e.g., the checkout station 215) and ESLs 205 may access the unified database to retrieve updated pricing and other product information.

Although a central server 220 is depicted within the perishable shrink control system 200, in some embodiments, the system 200 may include more than one server, and the functionality of analyzing images to identify products on the shelves, estimating stock levels, and determining price or supply adjustments may be distributed across these servers. The distributed server architecture may share the computation load across multiple servers, thereby improving the system's scalability and reliability.

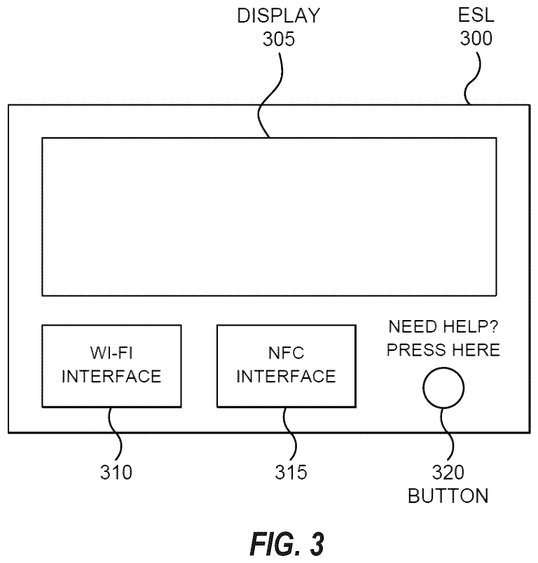

FIG. 3 depicts an example electronic shelf label (ESL) 300, according to some embodiments of the present disclosure. The illustrated ESL 300 may correspond to the shelf IO device 120 as depicted in FIG. 1. As illustrated, the ESL 300 includes a display 305, a Wi-Fi interface 310, a near field communication (NFC) interface 315, and a button 320. The display 305 may be an electronic ink display, which saves power relative to other types of display screens. When the ESL 300 operates on battery power, the display 305 may be an electronic ink display. In embodiments where the ESL 300 is coupled to a power source rather than being battery operated, the display 305 may be other types of displays, such as LED or LCD. In some embodiments, the display 305 may be a touch screen so that a user can interact with it, such as by selecting a virtual button indicating the customer wants help or advice from an expert.

The Wi-Fi interface 310 can include a transmitter/receiver (transceiver) for transmitting and receiving Wi-Fi data. The Wi-Fi interface 310 may connect the ESL 300 to a perishable shrink control system (e.g., 200 of FIG. 1) through a gateway (e.g., 225 of FIG. 2), which manages a Wi-Fi network in the retail environment. The wireless connectivity may allow the ESL 300 to receive real-time updates on pricing and other product information, to ensure that the displayed data is current and accurately reflects the system's dynamic adjustments.

The NFC interface 315 permits the ESL 300 to use NFC to communicate with store employees' devices as well as the customer's user devices. A store employee can use the NFC interface 315 to update the display 305 without the need for direct physical access or manual data entry, or the customer's user device may use the NFC interface 315 to receive pricing or other product information.

The button 320 can be a physical actuated button or a capacitive button. In this example, the ESL 300 includes printed text that instructs a customer to press the button 320 if they need help (e.g., to contact an expert). This text could be printed on the ESL 300 or could be output on the display 305.

The illustrated ESL 300 represents just one example of the ESL and its features. For example, other ESL implementations may not include all the features shown. One ESL may include the Wi-Fi interface 310, but not the NFC interface 315 or the button 320. Another ESL may include the NFC interface 315 but not the Wi-Fi interface 310 or the button 320. Yet another ESL may include the Wi-Fi interface 310 and the button 320, but not the NFC interface 315.

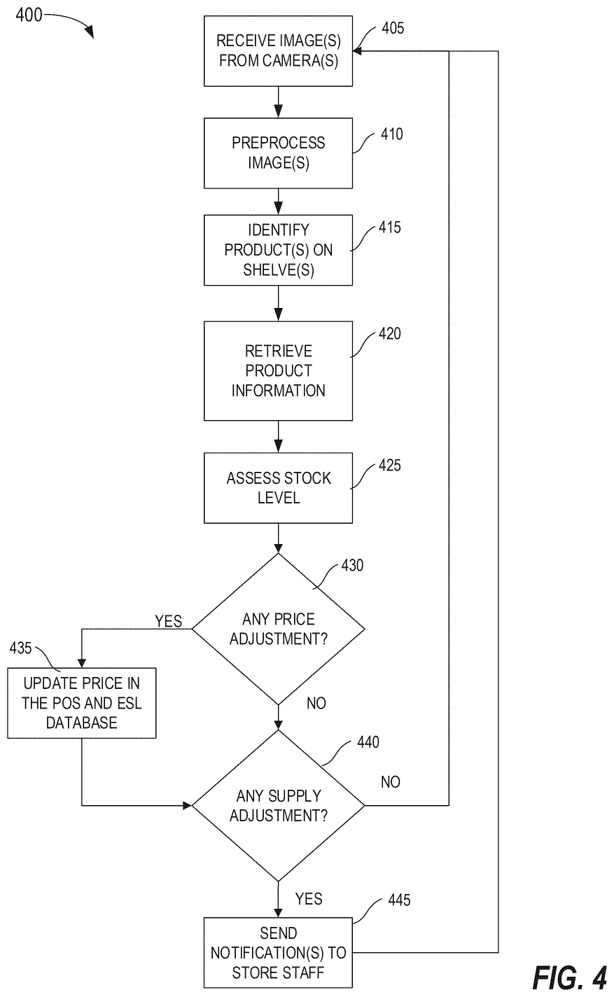

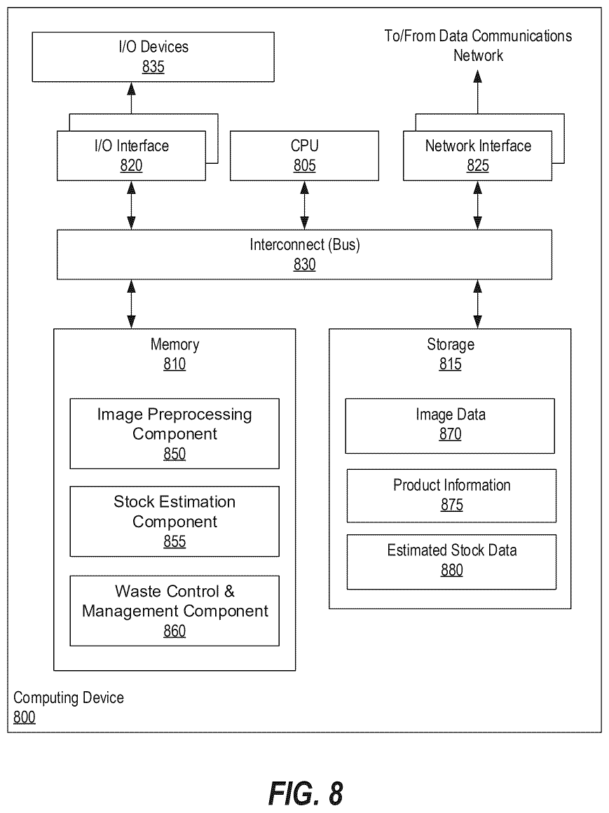

FIG. 4 depicts an example method 400 for controlling perishable shrink through, according to some embodiments of the present disclosure. In some embodiments, the method 400 may be performed by one or more computing devices, such as the server 220 as depicted in FIG. 2, and/or the computing device 800 as depicted in FIG. 8.

The method 400 begins at block 405, where a perishable shrink control server (e.g., 220 of FIG. 2) receives images from cameras installed through an enterprise site (e.g., a retail store). The images depict shelves (e.g., 105 of FIG. 1) on the site, focusing on the displayed products and their arrangement.

At block 410, the server preprocesses these captured images to enhance their quality for further data analysis. The preprocessing may include adjusting the image parameters (e.g., brightness, contrast) and filtering out noises to improve the accuracy for subsequent image recognition operations. In some embodiments, the preprocessing may also include cropping the images to focus on relevant areas (e.g., the top level of a shelf), to ensure more efficient recognition and analysis.

At block 415, the server uses image recognition algorithms to identify products and their batches on the shelves. In some embodiments, the identification may involve analyzing visual features such as packaging details, labels, barcodes, or other identifiable marks unique to each product type or batch. For example, a GS1-128 barcode may include application identifiers for the Global Trade Item Number GTIN), indicating the product type, and additional identifiers for batch/lot number, weight, or other relevant product information. Items that share the same GS1-128 barcode indicate they are of the same product type and belong to the same batch. These barcodes are typically printed directly on the product packaging or displayed on ESLs, making them easily captured by the cameras.

At block 420, following the identification of products through their visual features and barcodes, the server retrieves detailed product information from the database (e.g., ESL database 235 of FIG. 2). In some embodiments, the product information may include the product name, product ID (e.g., SKU), expiration date, brand, and manufacturer information, among others.

At block 425, the server assesses stock levels for the identified products and their respective batches. In some embodiments, the assessment may involve a detailed analysis of the images received from the cameras, either counting visible items or estimating quantities based on the occupied space on the shelves.

At block 430, the server determines whether the price for a product should be adjusted to improve sales and/or reduce perishable shrink. In some embodiments, the price adjustment may be determined based on a variety of factors, including, but not limited to, the evaluated stock levels, the product expiration dates, calculated product margin, historical sales data and market trends, and/or anticipated near-future stock levels based on scheduled purchases of product. In some embodiments, a ML model, trained on historical patterns of sales, price changes, and customer response, may be utilized to predict the price adjustment. In some embodiments, the adjusted price may accelerate sales (thereby reducing perishable shrink) while avoiding excessive reductions that could lead to significant revenues losses. If the server determines that a price for a certain product batch (e.g., Product A, Batch 110-1 of FIG. 1) should be adjusted, the method 400 proceeds to block 435, where the server communicates with the PoS database and ESL database to convey the updated pricing information. The synchronization ensures that the up-to-date prices are reflected at the checkout stations and on the ESLs. If, however, the server decides no price adjustment, the method 400 proceeds to block 440, where the server evaluates whether any changes to the supply are desirable, considering current stock levels, historical sales data, and customer behavior patterns, among others. Supply reduction may be desirable in embodiments where, despite a price reduction, the supply of a product remains high enough to risk perishable shrink. In such configurations, the server may recommend reducing incoming shipments or temporarily halting production to allow existing stock to sell through. Through such supply reductions, the server may effectively align supply more closely with demand, further reducing the potential for perishable shrink.

If the server determines that a supply adjustment should be implemented (e.g., reducing the order quantities for certain products), the method 400 proceeds to block 445, where the server sends notification to relevant store staff or departments. This may include alerting the supply chain management team or directly notifying the suppliers through an automated system to adjust production or distribution plans accordingly. The method 400 then returns to block 405. If, however, the server decides no supply adjustments are desired, or after the notifications have been sent, the method 400 returns to block 405, where the server continues to monitor stock levels within the enterprise site.

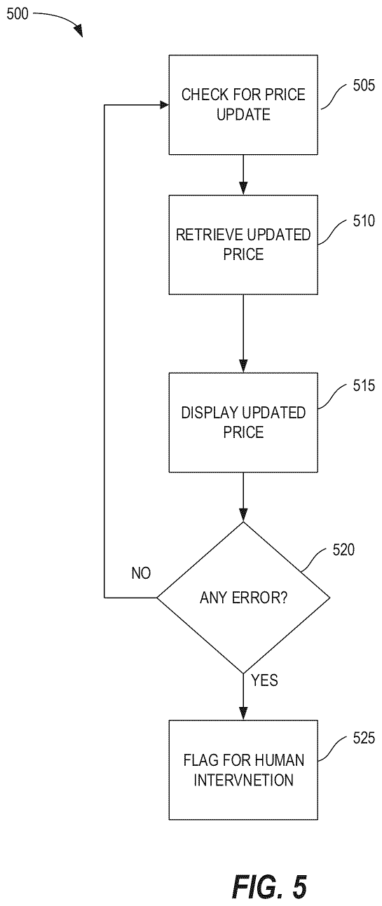

FIG. 5 depicts an example method 500 for ESL devices updating and displaying prices, according to some embodiments of the present disclosure. In some embodiments, the method 500 may be performed by the shelf IO device 120 as depicted in FIG. 1, and/or the ESL 205 as depicted in FIG. 2.

At block 505, an ESL (e.g., 205 of FIG. 2) actively checks for updates from the ESL database (e.g., 235 of FIG. 2) periodically, such as every hour or daily, depending on the retail operation's requirements and the ESL system's configuration. Alternatively, in other embodiments, the ESL database may be configured to send notifications to the connected ESL after a perishable shrink control server (e.g., 220 of FIG. 2) has updated the database with price adjustments. These notifications inform the ESL that updated pricing information is available, prompting it to retrieve and display the updated prices. Both methods (periodic checks and direct notification) ensure that the ESL remains current with the latest pricing information, and/or reflects any changes in a timely manner.

At block 510, upon notification or during a scheduled check, the ESL connects to the ESL database to retrieve the latest pricing information for the product it displays.

At block 515, the ESL processes the retrieved data, and updates its display (e.g., 305 of FIG. 3) to show the most current price.

At block 520, the ESL monitors for any errors in the price updating process. The potential errors may include issues such as communication failures (e.g., loss of Wi-Fi connectivity preventing the ESL from receiving notifications from the ESL database), data retrieval problems (e.g., the ESL database not responding or returning incomplete information), or failure in updating the display (e.g., the ESL screen remains unchanged due to hardware malfunctions). If an error is detected during this process, the method 500 proceeds to block 525, where the ESL proactively flags the issue for human intervention. In some embodiments, the ESL may send an alert to the store management system or directly notify store staff via their smartphones or tablets (e.g., 245 or 250 of FIG. 2). The alerts and/or notifications may include detailed information about the nature of the error and its location within the store, guiding staff to address the issue manually. If no error is detected, the method 500 returns to block 505, where the ESL continues to check for further updates and ensure that pricing information remains current.

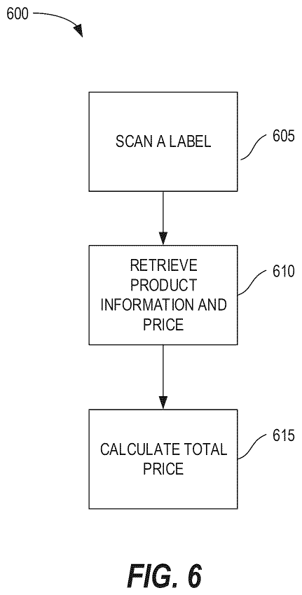

FIG. 6 depicts an example method 600 for POS devices retrieving updated prices upon product scanning, according to some embodiments of the present disclosure. In some embodiments, the method 600 may be performed by one or more PoS devices, such as the checkout station 215 as depicted in FIG. 2.

At block 605, a PoS device (e.g., the checkout station 215 of FIG. 2) scans a product's label, which can be a GS1 Logistic Label (1D barcode) or a GS1 Digital Link (2D barcode). The scanning operation may capture the product's unique identifier, such as GTIN, or other information encoded in the barcode, such as batch number or weight.

At block 610, the PoS device uses the product's unique identifier to retrieve detailed product information from the PoS database (e.g., 230 of FIG. 2). The product information may include the product name, description, SKU, expiration date, ingredient list, manufacturer information, and the most current price (which may have been dynamically updated by the store's perishable shrink control system), among others.

At block 615, the POS device calculates the total price for a customer's purchase. If multiple items are being purchased, operations at blocks 605 and 610 may be repeated for each item, with the total price calculated by cumulatively adding the price of the scanned items. The repeated process ensures that the final price accurately reflects any price adjustments that have been applied by the store's perishable shrink control system.

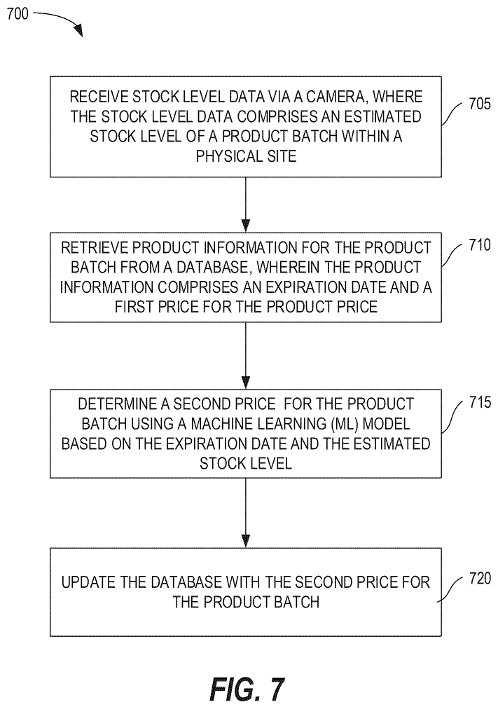

FIG. 7 is a flow diagram depicting an example method for dynamic pricing and inventory monitoring, according to some embodiments of the present disclosure.

At block 705, a computing device (e.g., server 220 of FIG. 2) receives stock level data via a camera (e.g., 125 of FIG. 1 or 210 of FIG. 2), where the stock level data comprises an estimated stock level of a product batch (e.g., Product A, Batch 110-1 of FIG. 1) within a physical site. In some embodiments, the product batch may comprise a group of items of a same type that share a matching expiration date.

In some embodiments, the camera may comprise an edge camera with built-in processing capability to generate one or more images of the product batch within the physical site, and use image recognition techniques to determine the estimated stock level of the product batch based on the one or more images.

At block 710, the computing device retrieves product information for the product batch from a database (e.g., 230 or 235 of FIG. 2), where the product information comprises an expiration date and a first price for the product price.

At block 715, the computing device calculates a second price for the product batch using a machine learning (ML) model based on the expiration date and the estimated stock level.

At block 720, the computing device updates the database with the second price for the product batch.

In some embodiments, the computing device may further send the second price for the product batch to a shelf input/output (IO) device. In some embodiments, the shelf IO device (e.g., 120 of FIG. 1, or 205 of FIG. 2) may be attached to a shelf presenting the product batch within the physical site. In some embodiments, the shelf IO device may be connected to the database to receive the second price for the product batch, and update a display screen (e.g., 305 of FIG. 3) of the shelf IO device based on the second price.

In some embodiments, a checkout station may be connected to the database to retrieve the second price for the product batch upon scanning a label associated with the product batch during a checkout process.

FIG. 8 depicts an example computing device configured to perform various aspects of the present disclosure, according to some embodiments of the present disclosure. Although depicted as a physical device, in some embodiments, the computing device 800 may be implemented using virtual device(s), and/or across a number of devices (e.g., in a cloud environment). The computing device 800 can be embodied as any computing device or system, such as the server 220 as illustrated in FIG. 2.

As illustrated, the computing device 800 includes a CPU 805, memory 810, storage 815, one or more network interfaces 825, and one or more I/O interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally considered to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated embodiment, the memory 810 includes an image preprocessing component 850, a stock estimation component 855, and a perishable shrink control component 860. Although depicted as a discrete component for conceptual clarity, in some embodiments, the operations of the depicted component (and others not illustrated) may be combined or distributed across any number of components. Further, although depicted as software residing in memory 810, in some embodiments, the operations of the depicted components (and others not illustrated) may be implemented using hardware, software, or a combination of hardware and software.

In the illustrated embodiment, the image preprocessing component 850 may process the raw image data received from the store's camera, and/or enhance its quality for further analysis. In some embodiments, the image preprocessing component 850 may adjust various image parameters, such as brightness and contrast, filter out noise, and/or crop the images to focus on certain areas of interest. After the images have been preprocessed, the stock estimation component 855 may analyze them to estimate stock levels for each product batch displayed on the shelves. The stock estimation component 855 may use image recognition algorithms to identify products and assess the quantity of stock available. The analysis may include counting visible items within the images or estimating quantities based on the space occupied by the products on the shelves. In some embodiments, the stock estimation component 855 may further retrieve detailed information for each identified product from the database. The detailed information may include, but is not limited to, product name, description, SKU, expiration date, manufacture information, and ingredient list. Based on the information provided by the stock estimation component 855, the perishable shrink control component 860 may determine the price and/or supply adjustments for each product. These adjustments may be determined based on a variety of factors, including but not limited to the proximity to the expiration date, the current stock level, and historical sales data. By considering these factors, the perishable shrink control component 860 may optimize pricing or supply strategies for products displayed to accelerate sales and reduce perishable shrink.

In the illustrated example, the storage 815 may include a variety of data to support the system's operations. The data may include, but is not limited to, raw image data 870 captured by the cameras within the store, detailed information 875 retrieved for products on the shelves, and their estimated stock levels 880. In some embodiments, the aforementioned data may be saved in a remote database (e.g., 230 or 235 of FIG. 2) that connects to the computing device 800 via a network.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in an manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., dynamic pricing & perishable shrink control application) or related data available in the cloud. For example, the dynamic pricing & perishable shrink control application may perform data processing and generate corresponding instructions through a cloud computing infrastructure, and store the relevant results in a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving stock level data via a camera, wherein the stock level data comprises an estimated stock level of a product batch within a physical site;
retrieving product information for the product batch from a database, wherein the product information comprises an expiration date and a first price for the product batch;
determining a second price for the product batch using a machine learning (ML) model based on the expiration date and the estimated stock level; and
updating the database with the second price for the product batch.

2. The method of claim 1, wherein the product batch comprises a group of items of a same type that share a matching expiration date.

3. The method of claim 1, wherein the camera comprises an edge camera with built-in processing capability to:
generate one or more images of the product batch within the physical site; and
use image recognition techniques to determine the estimated stock level of the product batch based on the one or more images.

4. The method of claim 1, further comprising sending the second price for the product batch to a shelf input/output (IO) device.

5. The method of claim 4, wherein the shelf IO device is attached to a shelf presenting the product batch within the physical site.

6. The method of claim 4, wherein the shelf IO device is connected to the database to:
receive the second price for the product batch; and
update a display screen of the shelf IO device based on the second price.

7. The method of claim 1, wherein a checkout station is connected to the database to retrieve the second price for the product batch upon scanning a label associated with the product batch during a checkout process.

8. A system, comprising:
one or more processors;
one or more memories storing a program, which, when executed on any combination of the one or more processors, performs operations, the operations comprising:
receiving stock level data via a camera, wherein the stock level data comprises an estimated stock level of a product batch within a physical site;
retrieving product information for the product batch from a database, wherein the product information comprises an expiration date and a first price for the product batch;
determining a second price for the product batch using a machine learning (ML) model based on the expiration date and the estimated stock level; and
updating the database with the second price for the product batch.

9. The system of claim 8, wherein the product batch comprises a group of items of a same type that share a matching expiration date.

10. The system of claim 8, wherein the camera comprises an edge camera with built-in processing capability to:
generate one or more images of the product batch within the physical site; and
use image recognition techniques to determine the estimated stock level of the product batch based on the one or more images.

11. The system of claim 8, wherein the program, which, when executed on any combination of the one or more processors, performs the operations further comprising sending the second price for the product batch to a shelf input/output (IO) device.

12. The system of claim 11, wherein the shelf IO device is attached to a shelf presenting the product batch within the physical site.

13. The system of claim 11, wherein the shelf IO device is connected to the database to:
receive the second price for the product batch; and
update a display screen of the shelf IO device based on the second price.

14. The system of claim 8, wherein a checkout station is connected to the database to retrieve the second price for the product batch upon scanning a label associated with the product batch during a checkout process.

15. One or more non-transitory computer-readable media containing, in any combination, computer program code that, when executed by operation of a computer system, performs operations comprising:
receiving stock level data via a camera, wherein the stock level data comprises an estimated stock level of a product batch within a physical site;
retrieving product information for the product batch from a database, wherein the product information comprises an expiration date and a first price for the product batch;
determining a second price for the product batch using a machine learning (ML) model based on the expiration date and the estimated stock level; and
updating the database with the second price for the product batch.

16. The one or more non-transitory computer-readable media of claim 15, wherein the product batch comprises a group of items of a same type that share a matching expiration date.

17. The one or more non-transitory computer-readable media of claim 15, wherein the camera comprises an edge camera with built-in processing capability to:
generate one or more images of the product batch within the physical site; and
use image recognition techniques to determine the estimated stock level of the product batch based on the one or more images.

18. The one or more non-transitory computer-readable media of claim 15, wherein the computer program code that, when executed by operation of a computer system, performs the operations further comprising sending the second price for the product batch to a shelf input/output (IO) device.

19. The one or more non-transitory computer-readable media of claim 18, wherein the shelf IO device is attached to a shelf presenting the product batch within the physical site, and the shelf IO device is connected to the database to:
receive the second price for the product batch; and
update a display screen of the shelf IO device based on the second price.

20. The one or more non-transitory computer-readable media of claim 15, wherein a checkout station is connected to the database to retrieve the second price for the product batch upon scanning a label associated with the product batch during a checkout process.
